(19) United States
(12) Patent Application Publication
(10) Pub. No.: US 2005/0182955 A1
(43) Pub. Date: Aug. 18, 2005

(54) Apparatus and method for securing external memory for portable terminal

(75) Inventor: Hyun-Seok Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/039,855

(22) Filed: Jan. 24, 2005

(30) Foreign Application Priority Data
Feb. 17, 2004 (KR) 2004-10281

(51) Int. Cl. H04L 9/32

(52) U.S. Cl. 713/193

(57) ABSTRACT

A method for securing an external memory for a portable terminal. The method includes operating a security function for the external memory when the external memory is inserted into the portable terminal, encrypting files and storing the encrypted files in the external memory during the operation of the security function for the external memory, and decrypting the encrypted files in the external memory when the security function for the external memory is released.

### CROSS-REFERENCE TO RELATED APPLICATIONS

This application claims the benefit under 35 U.S.C. §119(a) of Korean Patent Application No. 10-2004-0010281 entitled “Method for Securing External Memory for Portable Terminal” filed in the Korean Intellectual Property Office on Feb. 17, 2004, the entire contents of which are incorporated herein by reference.

### BACKGROUND OF THE INVENTION

1. Field of the Invention

The present invention relates generally to an external memory for a portable terminal. More particularly, the present invention relates to a method for securing the files of an external memory that can be inserted into and extracted from a portable terminal.

2. Description of the Related Art

With the rapid spread of portable terminals, the use of such portable terminals has become commonplace, leading to a trend toward developing more complex portable terminals having not only simple calling functions, but also including various functions to meet users' other demands. Also, with the opening of wireless networks, the rapid progress in wireless networks, and the increasing supply of high-end terminals, greater supply chains for various and dynamic contents have become visible. Also, memory and data communication fees have emerged as major issues for service providers and users due to the demands for large-scale contents according to such changes in environments.

To meet the demands for large-scale contents, an external memory that can be inserted into and extracted from a portable terminal has been recently provided along with an internal memory. However, the external memory may be inserted into another portable terminal of a third party without the awareness of a user of the portable terminal, and files of the external memory may then be used by the third party without a users' knowledge.

Accordingly, a need exists for a system and method to protect the files of such an external memory.

### SUMMARY OF THE INVENTION

It is, therefore, an object of the present invention to provide a method for securing the files of an external memory that can be inserted into and extracted from a portable terminal.

To achieve the above and other objects, a method is provided for securing an external memory for a portable terminal. The external memory can be provided as an extractable external memory, wherein the extractable external memory includes an identifier (ID). The method comprises the steps of operating a security function for the external memory when the external memory is inserted into the portable terminal, encrypting files and storing the encrypted files in the external memory during the operation of the security function for the external memory, and decrypting the encrypted files in the external memory when the security function for the external memory is released.

The method can further comprise separately, or in addition to the above steps, the steps of determining whether an external memory belongs to a user of the portable terminal when it is inserted into the portable terminal, operating a security function for the external memory if the inserted external memory belongs to the user, encrypting files and storing the encrypted files in the external memory during the operation of the security function for the external memory, and decrypting the encrypted files in the external memory when the security function for the external memory is released.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to an embodiment of the present invention; and

FIGS. 2A and 2B are flowcharts illustrating a method for securing an external memory for a portable terminal according to an embodiment of the present invention.

Throughout the drawings, like reference numerals will be understood to refer to like parts, components and structures.

### DETAILED DESCRIPTION OF THE EXEMPLARY EMBODIMENTS

Exemplary embodiments of the present invention will now be described in greater detail with reference to the annexed drawings. In the drawings, the same or similar elements are denoted by the same reference numerals even though they are depicted in different drawings. In the following description, detailed descriptions of known functions and configurations incorporated herein have been omitted for conciseness.

In the exemplary embodiment of the present invention, a portable terminal having a camera will be described as an example. However, the present invention can also be applied to general portable terminals without cameras, and still further applied to portable terminals having TV receivers in substantially the same manner as applied to portable terminals having cameras.

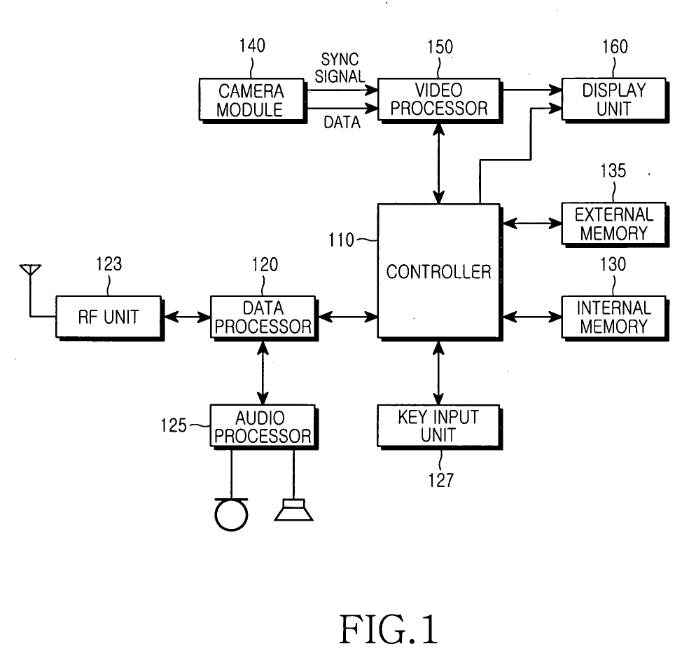

FIG. 1 is a block diagram of a portable terminal according to an exemplary embodiment of the present invention, in which, the configuration of a portable terminal having a camera is shown.

Referring to FIG. 1, a radio frequency (RF) unit 123 performs radio communication functions of the portable terminal. The RF unit 123 includes an RF transmitter for up-converting a frequency of a transmission signal and amplifying the up-converted transmission signal, and an RF receiver for low-noise-amplifying a received signal and down-converting a frequency of the low-noise-amplified signal. A data processor 120 includes a transmission block for encoding and modulating the transmission signal, and a reception block for decoding and demodulating the received signal. The blocks of the data processor 120 can be comprised of a modem and a codec. The codec includes a data codec for processing packet data and an audio codec for processing audio signals like voice. An audio processor 125 reproduces a reception audio signal output from the audio codec of the data processor 120, or transmits a transmission audio signal generated from a microphone to the audio codec of the data processor 120.

A memory is provided and can be comprised of an internal memory 130 and an external memory 135. The internal memory 130 is embedded in the portable terminal and is comprised of program memories and data memories. The program memories can store programs for controlling general operations of the portable terminal and programs for controlling a security function for files of the external memory 135. Also, the data memories can further temporarily store data generated during the execution of the programs.

The external memory 135 can be inserted into and extracted from the portable terminal, and can store various data such as MP3 music data, audio data, and photo album data. When the external memory 135 is inserted into the portable terminal, a user of the portable terminal can access and use the data stored in the external memory 135, and access and store data in the external memory 135. Also, the external memory 135 stores files that are encrypted when a security function is set, and stores files that are decrypted when the security function is released.

A controller 110 controls the overall operation of the portable terminal, and may also include the data processor 120. The controller 110 encrypts the files stored in the external memory 135 when the security function for the external memory 135 is set, or decrypts the files stored in the external memory 135 during the use of the files. The controller 110 also decrypts the files that are encrypted and stored in the external memory 135 when the security function for the external memory 135 is released.

A camera module 140 includes a camera sensor for photographing an image and converting photographed optical signals into electric signals, and a signal processor for converting analog video signals photographed by the camera sensor into digital data. Herein, the camera sensor of the exemplary embodiment shown can be comprised of a charge coupled device (CCD) sensor, and the signal processor can be implemented with a digital signal processor (DSP). Also, the camera sensor and the signal processor can be implemented into one body, or can be separately implemented.

A video processor 150 generates screen data for displaying video signals output from the camera module 140. The video processor 150 processes the video signals output from the camera module 140 frame by frame, and matches the frame video data to the characteristic and size of a display unit 160. Also, the video processor 150 includes a video codec, and compresses the frame video data displayed on the display unit 160 or decompresses compressed frame video data into the original frame video data. The video codec may be JPEG codec, MPEG4 codec, or Wavelet codec. Also in this example, the video processor 150 includes an on-screen display (OSD) function and can output OSD data according the size of a displayed screen under the control of the controller 110.

The display unit 160 displays video signals output from the video processor 150 on a screen, and can further display user data output from the controller 110. The display unit 160 may be a liquid crystal display (LCD), and if so, the display unit 160 may further include an LCD controller, a memory that can store video data, and an LCD display device. When the LCD is implemented with a touch screen, it may also serve as an input unit. Also, the display unit 160 can display messages for setting and releasing the security function for the external memory 135.

A key input unit 127 can be provided and includes keys for inputting number and character information, and function keys for setting various functions. Also, the key input unit 127 may include keys for setting and releasing the security function for the external memory 135.

An operation of the portable terminal will now be described in greater detail with reference to FIG. 1. Once a user dials and sets a calling mode through the key input unit 127 for sending a call, the controller 110, upon sensing the user's manipulation, processes dial information received through the data processor 120 and converts the processed dial information into an RF signal through the RF unit 123. Thereafter, once a called subscriber generates a response signal, the RF unit 123 and the data processor 120 sense the response signal. The user then communicates with the called party using a speech path formed through the audio processor 125.

In an incoming mode, the controller 110 senses the setting of the incoming mode through the data processor 120, and generates a ring signal through the audio processor 125. Upon receiving a response from the user, the controller 110 allows the user to communicate with the called party using the speech path formed through the audio processor 125. In both the calling and incoming modes, speech communication has been presented as an example, but data communication for packet data and video data may also be performed in a substantially similar manner. Also, in a waiting mode or character communication, the controller 110 displays character data processed by the data processor 120 on the display unit 160.

An operation for securing files of the external memory 135 in the portable terminal will be now be described in greater detail. When the external terminal 135 is inserted into the portable terminal, the controller 110 senses the insertion and operates the security function for the external memory 135. When the user of the portable terminal stores files in the external memory 135 during the operation of the security function for the external memory 135, the files are encrypted and then stored in the external memory 135. When the user of the portable terminal uses the files stored in the external memory 135, the controller 110 decrypts the files during use. When the user selects the release of the security function during the operation of the security function, the controller 110 senses the user's selection and decrypts the encrypted files stored in the external memory 135.

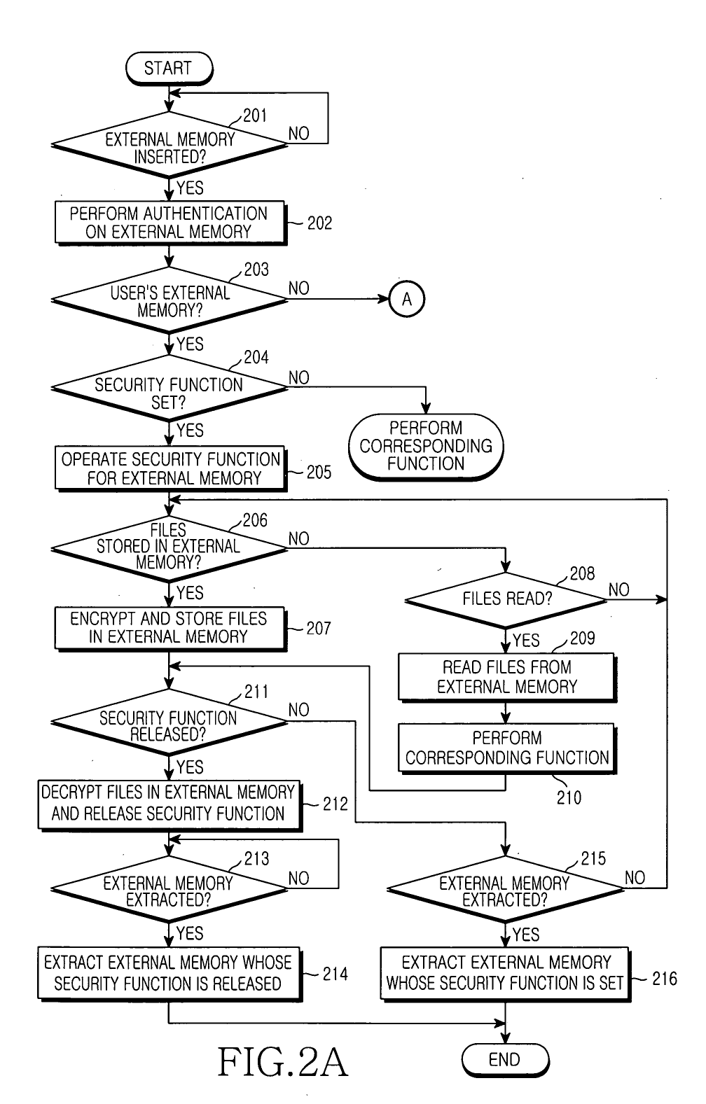

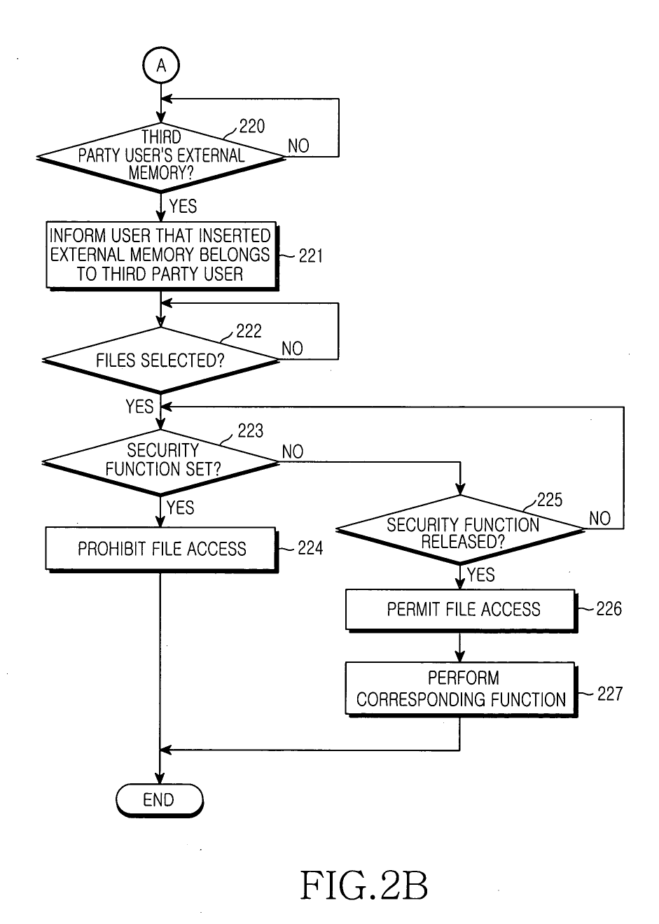

FIGS. 2A and 2B are flowcharts illustrating a method for securing an external terminal for a portable terminal according to an embodiment of the present invention. In this embodiment, files stored in the external memory 135 are encrypted using a DES (Data Encryption Standard) algorithm by way of example. However, the present invention can also adopt other various encryption methods besides the encryption method using the DES algorithm. The DES algorithm is widely used as a technique for encrypting data using private keys. In the DES algorithm, 72,000,000,000,000,000 (72 thousand trillion) encryption keys or more are available. Keys for each given message are randomly selected from such numerous keys. As is usual with private key encryption methods, both a transmitter and a receiver should use the identical private key to communicate with each other.

Hereinafter, an exemplary embodiment of the present invention will be described in greater detail with reference to FIGS. 1, 2A and 2B. Referring to FIGS. 2A and 2B, once an external memory is inserted into the portable terminal, the controller 110 senses the insertion in step 201 and then proceeds to step 202. In step 202, the controller 110 performs authentication on the inserted external memory, in which it is determined whether the inserted external memory is the external memory 135 of the user of the portable terminal. If it is determined through the authentication on the inserted external memory that an identifier (ID) of the inserted external memory is identical to an ID stored in the internal memory 130 of the portable terminal in step 203, the controller 110 determines in step 204 whether the security function for the external memory 135 is set in the portable terminal.

If the inserted external memory 135 is authenticated as a memory of the user, the controller 110 controls the display unit 160 to display a message that questions the user as to whether to set the security function for the external memory 135. When the security function for the external memory 135 is not set in the portable terminal or the user selects the release of the security function for the external memory 135, the controller 110 senses the fact in step 204 and performs a general function of storing or reading files into or from the external memory 135.

However, when the security function for the external memory 135 is set in the portable terminal or the user selects setting of the security function for the external memory 135, the controller 110 senses the fact in step 204 and then proceeds to step 205 where it operates the security function for the external memory 135. For example, when the user of the portable terminal takes still pictures or moving pictures during the operation of the security function for the external memory 135 and stores corresponding files in the external memory 135, the controller 110 senses the storage of the files in step 206 and then proceeds to step 207. In step 207, the controller 110 encrypts the files using the DES algorithm and then stores the encrypted files in the external memory 135.

When the user selects a specific key to use the files stored in the external memory 135, the controller 110 senses the key selection in step 208, and then proceeds to step 209. In step 209, the controller 110 reads the selected files and decrypts the read files again using the DES algorithm. In step 210, the controller 110 performs a corresponding function using the read files. Thereafter, the controller 110 can repeat steps 206 and 207 if it is necessary to again encrypt and store the read files.

When the user of the portable terminal selects the release of the security function for the external memory 135 while storing the encrypted files in the external memory 135 or while decrypting the encrypted files stored in the external memory 135 using the security function, the controller 110 senses the user's selection in step 211 and then proceeds to step 212. In step 212, the controller 110 decrypts the encrypted files stored in the external memory 135 and releases the security function for the external terminal 135. When the external memory 135 is extracted from the portable terminal after release of the security function, the controller 110 senses the extraction in step 213 and then proceeds to step 214.

In step 214, if the extracted external memory 135 whose security function is released is inserted into portable terminals or computers of other users, the files stored in the external memory 135 can be used. However, if the external memory 135 is extracted without release of the security function, the controller 110 senses the extraction of the external memory 135 whose security function is not released in step 215 and then proceeds to step 216. In step 216, if the extracted external memory 135 whose security function is not released is inserted into portable terminals or computers of other users, the files stored in the external memory 135 cannot be used.

If it is determined in step 203 that the inserted external memory is not the external memory 135 of the user of the portable terminal, the controller 110 then determines if the external memory is that of a third party user in step 220 in FIG. 2B, and then proceeds to step 221 where it informs the user that the inserted external memory belongs to a third party user. When the user of the portable terminal then selects the files stored in the external memory 135, the controller 110 senses the user's selection in step 222 and determines whether a security function for the external terminal of the third party user is set. If the security function for the external memory of the third party user is set, the controller 110 senses the setting of the security function in step 223 and then proceeds to step 224, where it informs the user that files stored in the external memory of the third party user cannot be used. However, if it is determined in step 223 that the security function for the external memory of the third party user is released, the controller 110 senses release of the security function in step 225 and then proceeds to step 226. In step 226, the controller 110 informs the user that files stored in the external memory of the third party user can be used. Thereafter, in step 227, the controller 110 selects the files stored in the external memory of the third party user and performs a corresponding function. Therefore, the present invention secures files stored in an external memory for a portable terminal, thereby preventing a third party user from using a user's external memory without permission.

While the invention has been shown and described with reference to certain exemplary embodiments thereof, it will be understood by those skilled in the art that various changes in form and details may be made therein without departing from the spirit and scope of the invention as defined by the appended claims.

1. A method for securing an external memory for a portable terminal, the method comprising the steps of:
operating a security function for the external memory when the external memory is inserted into the portable terminal;
encrypting files and storing the encrypted files in the external memory during the operation of the security function for the external memory; and
decrypting the encrypted files in the external memory when the security function for the external memory is released.

2. The method of claim 1, wherein the step of operating a security function for the external memory comprises the steps of:
determining whether the security function for the external memory is set when the external memory is inserted into the portable terminal; and
operating the security function for the external memory when the security function for the external memory is set.

3. The method of claim 1, further comprising the step of setting or releasing the security function for the external memory.

4. The method of claim 1, further comprising the step of:
permitting a use of the files stored in the external memory when the external memory has a released security function and is extracted from the portable terminal and then inserted into another portable terminal.

5. The method of claim 1, further comprising the step of:
prohibiting a use of the files stored in the external memory when the external memory has a set security function and is extracted from the portable terminal and then inserted into another portable terminal.

6. A method for securing an external memory for a portable terminal, the method comprising the steps of:
determining whether an external memory belongs to a user of the portable terminal when the external memory is inserted into the portable terminal;
operating a security function for the external memory if the inserted external memory belongs to the user;
encrypting files and storing the encrypted files in the external memory during the operation of the security function for the external memory; and
decrypting the encrypted files in the external memory when the security function for the external memory is released.

7. The method of claim 6, further comprising the steps of:
determining whether a security function for the inserted external memory is set if the inserted external memory does not belong to the user;
prohibiting the use of files of the external memory if the security function for the inserted external memory is set; and
permitting the use of the files of the external memory if the security function for the inserted external memory is released.

8. An external memory securing apparatus for a portable terminal, comprising:
a memory comprising at least one of an internal memory and an extractable external memory, wherein the extractable external memory comprises an identifier (ID); and
a controller for encrypting files stored in the external memory when a security function for the external memory is set, for decrypting files stored in the external memory during the use of the files, and for decrypting files that are encrypted and stored in the external memory when the security function for the external memory is released.
